(19) United States
(12) Patent Application Publication
(10) Pub. No.: US 2020/0193026 A1
(43) Pub. Date: Jun. 18, 2020

(54) APPLICATION UPDATES DETECTION IN DATA CENTERS

(71) Applicant: VMWARE, INC., Palo Alto, CA (US)

(72) Inventors: VAIBHAV REKHATE, Pune (IN); Nilesh Awate, Pune (IN); Michael Larkin, Palo Alto, CA (US); Yi Sun, Palo Alto, CA (US)

(21) Appl. No.: 16/398,318

(22) Filed: Apr. 30, 2019

(30) Foreign Application Priority Data
Dec. 18, 2018 (IN) 201841047907

(51) Int. Cl. G06F 21/57; G06F 8/65

(52) U.S. Cl. CPC G06F 21/572; G06F 2221/033; G06F 8/65

(57) ABSTRACT

Techniques for detecting application updates in data centers are disclosed. In one example, process information and corresponding metadata associated with a first process event of an application running on a first application host may be received. Upon receiving, the metadata associated with the first process event may be compared with statistical metadata associated with a previous version of the application using the process information. Further, the first process event may be detected as associated with a valid upgrade of the application based on the comparison and an application in-guest unit running on the first application host may be notified that the first process event is associated with the valid upgrade based on the detection.

### RELATED APPLICATIONS

Benefit is claimed under 35 U.S.C. 119(a)-(d) to Foreign Application Serial No. 201841047907 filed in India entitled “APPLICATION UPDATES DETECTION IN DATA CENTERS”, on Dec. 18, 2018, by VMWARE, INC., which is herein incorporated in its entirety by reference for all purposes.

### TECHNICAL FIELD

The present disclosure relates to computing environments, and more particularly to methods, techniques, and systems for detecting application updates in data centers.

### BACKGROUND

In computing environments, applications running on application hosts may be monitored upgrade in application functionality, bugs in the application, incorrect application rollout, or the like. to ensure that the application processes and performs in an intended manner. An application host may be a physical computer, a virtual machine, a container, and the like. Monitoring the application may include understanding an intended process behavior (e.g., network connections, system calls, and the like) of an application and tracking process behavior for any deviation from the intended process behavior. For example, the process behavior of the application may deviate from the intended process behavior for various reasons such as an

### BRIEF DESCRIPTION OF THE DRAWINGS

FIG. 1 is a block diagram of an example system, including an application update detection unit to detect an update associated with an application;

FIG. 2 is an example flow diagram illustrating detecting an update associated with an application based on process information and corresponding metadata;

FIG. 3 is a block diagram of an example system illustrating a process to detect an update of an application based on process information and metadata;

FIG. 4 is an example flow diagram illustrating detecting and notifying an update of an application based on process information and corresponding metadata; and

FIG. 5 is a block diagram of an example computing device including non-transitory computer-readable storage medium storing instructions to detect and notify an update of an application.

The drawings described herein are for illustration purposes only and are not intended to limit the scope of the present subject matter in any way.

### DETAILED DESCRIPTION

Examples described herein may provide an enhanced computer-based and network-based method, technique, and system for detecting application updates in data centers. A data center may be a physical data center (e.g. an on-premise enterprise computing environment) and/or virtual data center (e.g., a cloud computing environment, a virtualized environment, and the like). The virtual data center may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual data center may be a virtual representation of a physical data center, complete with servers, storage clusters, and networking components, all of which may reside in virtual space being hosted by one or more physical data centers.

Further, the data center may include a plurality of application hosts executing a plurality of applications. Example application host may be a physical computer, a virtual machine, a container, and the like. Further, the plurality of applications may be monitored to track the process behavior (e.g., network connections, system calls, and the like) of the applications and to rectify abnormalities or shortcomings, if any. Application monitoring may be referred as application performance monitoring (APM) and/or application performance management (APM).

Furthermore, a deviation of the process behavior from an intended process behavior of the application may be considered as malicious behavior. However, the process behavior of the application may deviate from the intended process behavior for various reasons which may or may not be considered as malicious behavior. For example, the application may be upgraded/updated to include new features and/or fixing issues with existing features (e.g., bug fixes, fixing vulnerabilities, and the like). Thus, when the application is upgraded, the behavior of the process behavior may be deviated. In this case, the deviation of the process behavior may not be considered as malicious behavior. Further, the deviation of the process behavior due to bugs in the application, incorrect application rollout, or the like may have to be considered as malicious behavior. However, detecting application updates may be challenging in the data centers.

Examples described herein may detect an update of an application in a data center. Examples described herein may receive process information and corresponding metadata associated with a process event of the application running on an application host, compare the metadata associated with the process event with statistical metadata associated with a previous version of the application using the process information, detect that the process event is associated with a valid upgrade of the application based on the comparison, and notify an application in-guest unit running on the first application host that the process event is associated with the valid upgrade based on the detection.

System Overview and Examples of Operation

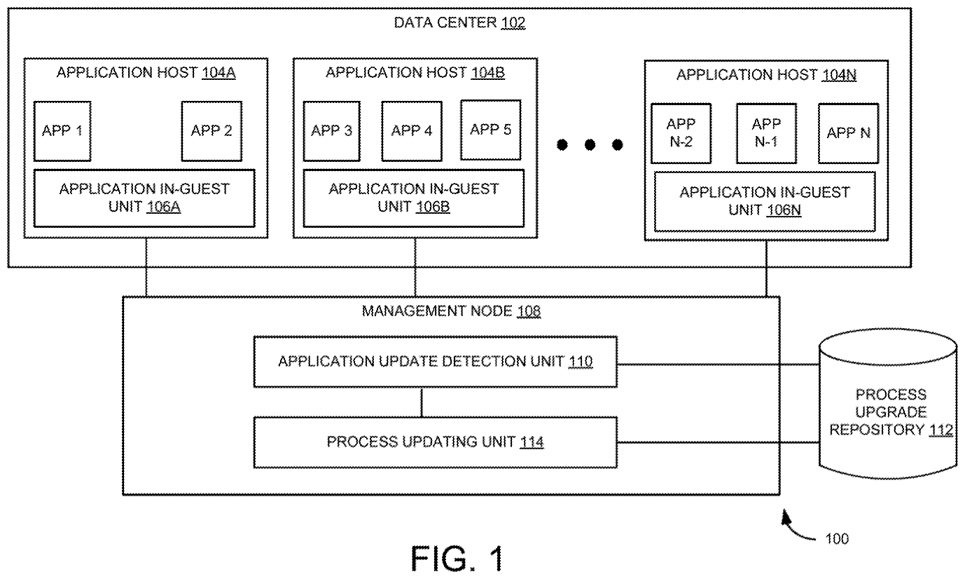

FIG. 1 is a block diagram of an example system 100 including an application update detection unit 110 to detect an update associated with an application (e.g., APP 1). System 100 may include a data center 102, which may be a physical data center and/or a virtual data center. As shown in FIG. 1, data center 102 may include a plurality of application hosts 104A-104N, each executing corresponding ones of applications APP 1 to APP N. Example application host (e.g., 104A-104N) may be a physical computer, a virtual machine, a container, or the like. The physical computer may be a hardware-based device (e.g., a personal computer, a laptop, or the like) including an operating system (OS) and executing applications. The virtual machine may operate with its own guest OS on the physical computer using resources of the physical computer virtualized by virtualization software (e.g., a hypervisor, a virtual machine monitor, and the like). The container may be a data computer node that runs on top of a host OS without the need for a hypervisor or separate OS. Further, an application (e.g., APP 1 to APP N) supported by an application host (e.g., 104A to 104N), also referred to as an application program or application software, may be a computer software package that performs a specific function directly for an end user or, in some cases, for another application. Examples of applications APP 1 to APP N may include word processors, database programs, web browsers, development tools, image editors, communication platforms, and the like. In one example, applications APP 1 to APP N may use application host's (e.g., 104A-104N) operating system (OS) and other supporting programs, such as system software, to function. The system software may manage operation of application host (e.g., 104A-104N) and may include the OS, a hypervisor, and drivers, and/or the like.

Further, application hosts 104A to 104N may include application in-guest units 106A to 106N, respectively. In one example, application in-guest units 106A to 106N may capture process information and corresponding metadata associated with process events of corresponding applications APP 1 to APP N. For example, application in-guest unit 106A may capture the process information and the corresponding metadata associated with a first process event of an application APP 1. Further, application in-guest unit 106A may transmit the captured process information and the corresponding metadata to application update detection unit 110 when the first process event is occurred for a first time (i.e., the first process event is associated with a new process).

As shown in FIG. 1, system 100 may include a management node 108 communicatively coupled to application hosts 104A to 104N via a network. Example network can be a managed Internet protocol (IP) network administered by a service provider. For example, the network may be implemented using wireless protocols and technologies, such as WiFi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 108 may be communicatively coupled to a process upgrade repository 112 to store statistical process information and corresponding metadata associated with the plurality of applications APP 1 to APP N. In one example, process upgrade repository 112 may reside in management node 108. In another example, process upgrade repository 112 may reside remotely and may be accessed by management node 108 via the network as shown in FIG. 1. Furthermore, management node 108 may include application update detection unit 110, which may be communicatively connected to process upgrade repository 112.

During operation, application update detection unit 110 may receive the process information and the corresponding metadata associated with the first process event of application APP 1 from application in-guest unit 106A running on first application host 104A. In one example, process information may include a process name of application APP 1 being executed, a name of the file being used by application APP 1, a file size, and the like. The metadata may include at least one of process binary hash information, process binary signing information (e.g., a digital certificate), and process publisher information (e.g., a file version, a product version, a product name, and the like).

Further, application update detection unit 110 may compare the metadata associated with the first process event with statistical metadata associated with a previous version of application APP 1. In one example, application update detection unit 110 may determine a process corresponding to the process information associated with the first process event from process upgrade repository 112, retrieve the statistical metadata associated with the previous version of application APP 1 from process upgrade repository 112 based on the determined process, and compare the metadata associated with the first process event with the retrieved statistical metadata.

Furthermore, application update detection unit 110 may detect that the first process event is associated with a valid upgrade of the application based on the comparison and notify application in-guest unit 106A that the first process event is associated with the valid upgrade based on the detection. Upon receiving the notification, application in-guest unit 106A may permit execution behavior of the first process event. In one example, the behavior may include at least one of network connections, system calls, and system files associated with the first process event. For example, permitting execution behavior may include correlating the behavior corresponding to the first process event with the behavior corresponding to the previous version of the application for monitoring application APP 1 running on first application host 104A. Thus, examples described herein may detect an upgrade of application APP 1 and associate the process behavior captured with older versions with the newer version of application APP 1 without compromising on security.

In another example, application update detection unit 110 may detect that the first process event is not associated with the valid upgrade of the application based on the comparison and notify application in-guest unit 106A that the first process event is not associated with the valid upgrade based on the detection. Upon receiving the notification, application in-guest unit 106A may exclude execution behavior of the first process event and generate an alert to resolve a cause for deviation in the process behavior, for instance.

As shown in FIG. 1, management node 108 may include a process updating unit 114 to update process upgrade repository 112 with an updated version of the application when application update detection unit 110 detects that the first process event is associated with the valid upgrade of the application. In other examples, process updating unit 114 may update process upgrade repository using at least one of upgrade catalogues and social assurance.

In one example, process updating unit 114 may receive upgrade catalogues corresponding to an updated version of the application, parse process information and corresponding metadata of a process associated with the updated version of the application from the upgrade catalogues, and update the process upgrade repository with the parsed process information and the corresponding metadata as the updated version of the application. In another example, process updating unit 114 may retrieve one or more process events associated with a valid upgrade of the application from plurality of application hosts 104A to 104N and update the process upgrade repository with process information and metadata associated with the retrieved one or more process events associated with the valid upgrade of the application.

Further during operation, application update detection unit 110 may receive process information and corresponding metadata associated with a second process event of application APP 3 running on a second application host 104B. Upon receiving, application update detection unit 110 may look-up process upgrade repository 112 to detect that the second process event is associated with the updated version of application APP 1 and notify an application in-guest unit 106B running on second application host 104B that the second process event is associated with the valid upgrade based on the detection. In one example, first application host 104A and second application host 104B may run in same data center 102 or different data centers. In other examples, first application host 104A and second application host 104B may run in the same cloud or different clouds.

In some examples, the functionalities described herein, in relation to instructions to implement functions of application update detection unit 110, process updating unit 114, and any additional instructions described herein in relation to the storage medium, may be implemented as engines or modules comprising any combination of hardware and programming to implement the functionalities of the modules or engines described herein. The functions of application update detection unit 110 and process updating unit 114 may also be implemented by a respective processor. In examples described herein, the processor may include, for example, one processor or multiple processors included in a single device or distributed across multiple devices.

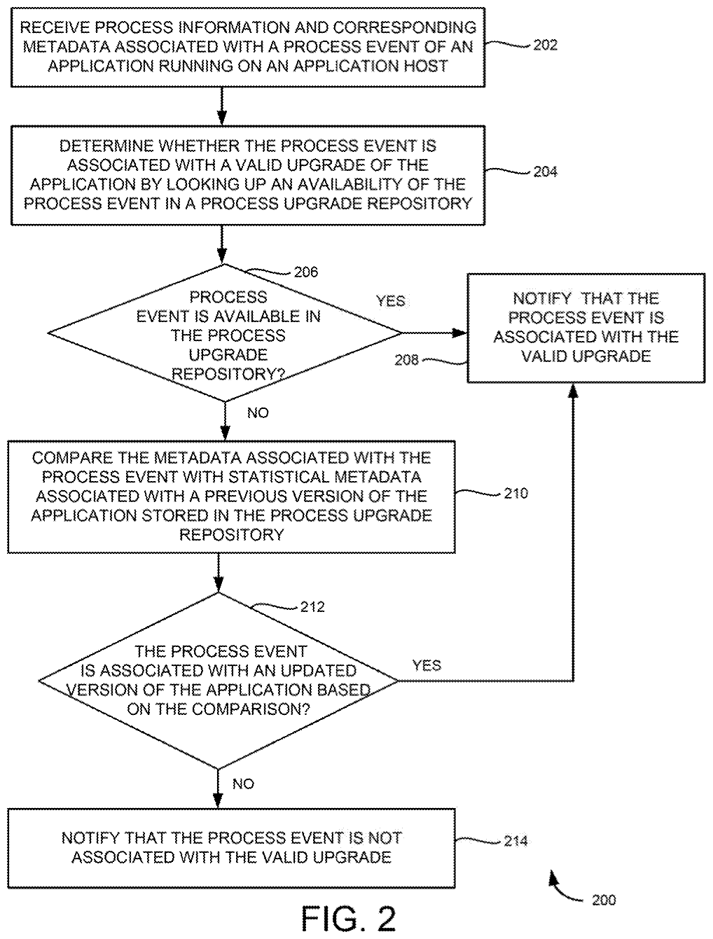

FIG. 2 is an example flow diagram 200 illustrating detecting an update associated with an application based on process information and corresponding metadata. It should be understood that the process depicted in FIG. 2 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 202, process information and corresponding metadata associated with a process event of the application running on an application host may be received. At 204, the process event may be analysed to determine whether the process event is associated with a valid upgrade of the application by looking up an availability of the process event in a process upgrade repository. At 206, a check is made to determine whether the process event is available in the process upgrade repository. In one example, looking up the availability of the process event may include checking the process upgrade repository if a process associated with the process event is a known upgrade (e.g., management node 108 of FIG. 1 has previously seen such an upgrade).

When the process event is available in the process upgrade repository, a notification may be sent to an application in-guest unit running on the application host that the process event is associated with the valid upgrade of the application, at 208. At 210, when the process event is not available in the process upgrade repository, the metadata (e.g., attributes such as process binary hash information, process binary signing information, and process publisher information) may be compared with statistical metadata associated with a previous version of the application stored in the process upgrade repository.

In one example, comparing the metadata associated with the process event with the statistical metadata associated with the previous version of the application may include determining a process corresponding to the process information (e.g., process name, file name, and the like) associated with the process event from the process upgrade repository. For example, for the process event associated with a new process, associated older versions are looked up in the process upgrade repository. For matching the processes, a look-up may be made on a process name, for instance. In some examples, the process name might contain version numbers (e.g., “Python™” versions are named as python2, python2.7, python3, python3.5, and the like). In this example, a fuzzy match may be used in which numbers are masked to identify older versions. Thus, the process in the process upgrade repository with identical publisher information (e.g., a product name, a company name, and the like) and with different product version or file version may be determined as the associated older version of the process.

Upon determining the process, the statistical metadata (e.g., process binary hash information, process binary signing information, and/or process publisher information) associated with the previous version of the application may be retrieved from the process upgrade repository and the metadata associated with the process event may be compared with the retrieved statistical metadata. In one example, the process binary signing information may be considered for comparison. For example, signing certificates associated with the process event and the older version of the application are compared. Further, if the signing certificate is expired, an issuer and signing key may be used to identify if the signer is identical for newer and older versions of the application.

At 212, a check is made to determine whether the process event is associated with the valid upgrade of the application based on the comparison. In the example, when the signing certificate or the signing key is identical, the process event may be considered as associated with the valid upgrade of the application. When the process event is associated with the valid upgrade of the application, a notification may be sent to an application in-guest unit running on the application host that the process event is associated with the valid upgrade, at 208. Further, the process upgrade repository may be updated with an updated version of the application upon detecting that the process event is associated with the valid upgrade of the application. At 214, when the process event is not associated with the valid upgrade of the application, a notification may be sent to the application in-guest unit running on the application host that the process event is not associated with the valid upgrade.

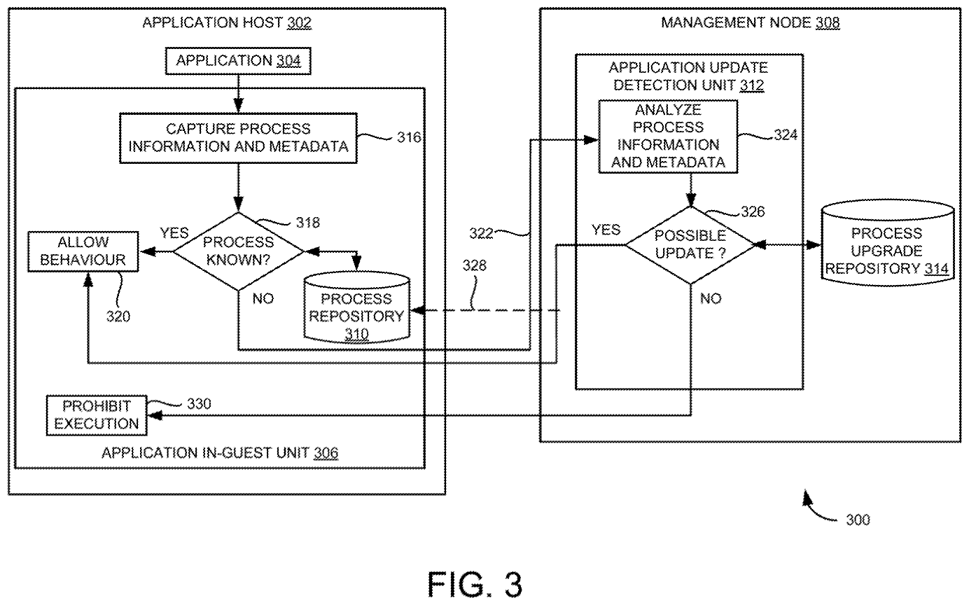

FIG. 3 is a block diagram of an example system 300 illustrating a process to detect an update of an application 304 based on process information and metadata. System 300 may include an application host 302 executing application 304. Further, application host 302 may include an application in-guest unit 306 running on application host 302. In one example, application in-guest unit 306 may register for process create events associated with application 304. For example, when a new process is launched, application in-guest unit 306 may get notified. The application in-guest unit 306 may capture process information along with its metadata (e.g., process binary hash, process binary signing information, and process publisher information), at 316.

In one example, to reduce activities or process flow between application in-guest unit 306 and management node 308, application in-guest unit 306 may maintain a cached local process repository 310 to store known processes for which no new events may be generated. In this example, at 318, application in-guest unit 306 may to determine whether the process event is associated with a known process using process repository 310. When the process is known, process behavior of the process event may be allowed as in 320. Further, when the process is not known, the captured information may be sent to management node 308 in cloud for analysis, at 322.

As shown in FIG. 3, management node 308 may include an application update detection unit 312 and process upgrade repository 314. At 324, application update detection unit 312 may analyse the received process information and the metadata. In one example, a check is made to determine whether the process event is associated with a valid upgrade of the application by looking up an availability of the process event in process upgrade repository 314. When the process event is not available in process upgrade repository 314, other attributes in the metadata may be analyzed. For example, signing certificates may be analyzed to determine whether a process associated with the process event matches with an existing process in process upgrade repository 314. When the signing certificates do not match, a check is made to determine whether signing keys matches.

At 326, application update detection unit 312 may determine whether the process event is associated with a possible update (e.g., the valid upgrade) based on the analysis in 324. In one example, when the process event is detected as associated with the valid upgrade of the application (e.g., by looking up process upgrade repository 314, when the signing certificates match, or when the signing keys match) the process event may be considered as associated with the valid upgrade of the application. Further, management node 308 may then connects back to application in-guest unit 306 with a notification that the process event is associated with a legitimate upgrade and to allow process behavior of the process event, at 320. Furthermore, management node 308 may then update process repository 310 and process upgrade repository 314 regarding the application update, at 328.

In another example, when the process event is not detected as associated with the valid upgrade of the application (e.g., by looking up process upgrade repository 314, when the signing certificates does not match, or when the signing keys does not match), the process event may not be considered as associated with the valid upgrade of the application. Further, management node 308 may then connects back to application in-guest unit 306 with a notification that the process event is not associated with a legitimate upgrade and to prohibit execution of the process event, at 330.

In other examples, process upgrade repository 314 may be updated using at least one of upgrade catalogues and social assurance. In one example, software vendors and developers may release upgrade catalogues of applications which may contain information about newly available software packages along with metadata about the process binaries in the software packages. Thus, upgrade catalogues may be subscribed and the information about the process binaries and their packages may be parsed to update process upgrade repository 314. In another example, as the logic for upgrade detection may run in the cloud and captures data from systems spread across application hosts, actions taken on various application hosts may be corelated to analyse process events coming from various application hosts (e.g., running in different cloud computing environments or data centers). If a particular process upgrade is marked as safe and known on a considerable number of application hosts, newer events may be marked as potential upgrades based on the social assurance and process upgrade repository 314 may be updated accordingly.

In yet another example, custom applications may be developed in-house for specific purposes and may not be made public. In this example, associated binaries may remain self-signed/unsigned, and may not make their way to the public upgrade catalogues. Thus, new process events for such processes may be sent to a security user/administrator for analysis. Once the user verifies these processes as potential upgrades of older process, they may be considered as valid upgrades and may get saved in process upgrade database 314. Further, subsequent events for the same process can then be recognised as valid upgrades.

Examples described herein may be implemented in software solutions like VMware® application security (e.g., “AppDefense”) application. The application security software may associate process behaviors with process/application binaries. For example, the processes may be identified based on file hashes (e.g. SHA256 hash) which may be used to uniquely identify a process binary. Once these behaviors are captured, the process behavior may be tracked to ensure that the process behavior does not deviate from the baseline behavior. In case of deviations, examples described herein may detect the misbehavior of the process/application and may send an alert to a security administrator. Thus, examples described herein may detect application upgrades so that the deviations due to application upgrades are not considered as misbehavior and the behaviors captured for attesting can also be applicable for newer process associated with the upgraded application.

Example Processes

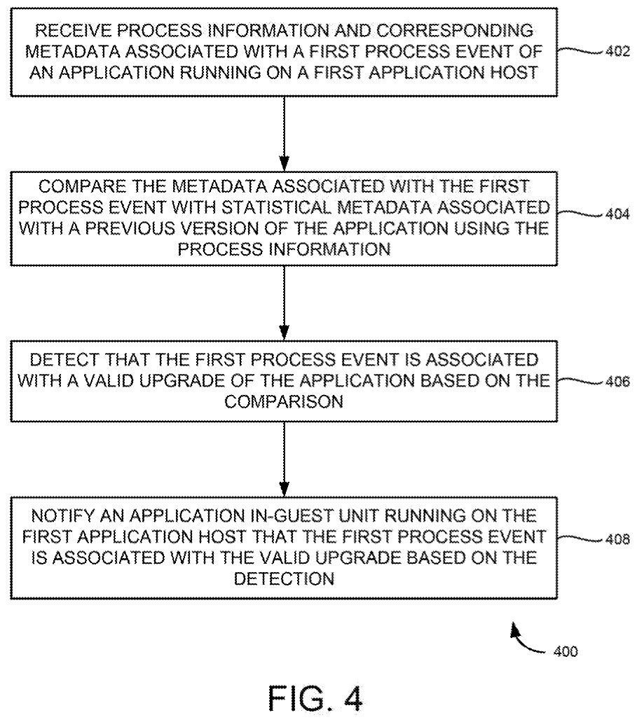

FIG. 4 is an example flow diagram 400 illustrating detecting an upgrade of an application based on process information and corresponding metadata. It should be understood that the process depicted in FIG. 4 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 402, process information and corresponding metadata associated with a first process event of an application running on a first application host may be received. At 404, the metadata associated with the first process event may be compared with statistical metadata associated with a previous version of the application using the process information. At 406, the first process event may be detected as associated with a valid upgrade of the application based on the comparison. At 408, an application in-guest unit running on the first application host may be notified that the first process event is associated with the valid upgrade based on the detection. Further, the process upgrade repository may be updated with an updated version of the application upon detecting that the first process event is associated with the valid upgrade of the application.

Example flow diagram 400 may further include correlating, by the application in-guest unit, behaviors corresponding to the first process event with behaviors corresponding to the previous version of the application when the first process event is associated with the valid upgrade. Further, example flow diagram 400 may include detecting that the first process event is not associated with the valid upgrade of the application based on the comparison and notifying the application in-guest unit running on the first application host that the first process event is not associated with the valid upgrade based on the detection.

Furthermore, example flow diagram 400 may include receiving process information and corresponding metadata associated with a second process event of the application running on a second application host, looking-up the process upgrade repository to detect that the second process event is associated with the updated version of the application, and notifying an application in-guest unit running on the second application host that the second process event is associated with the valid upgrade based on the detection. An example detection of an application upgrade is explained with respect to FIGS. 1-3.

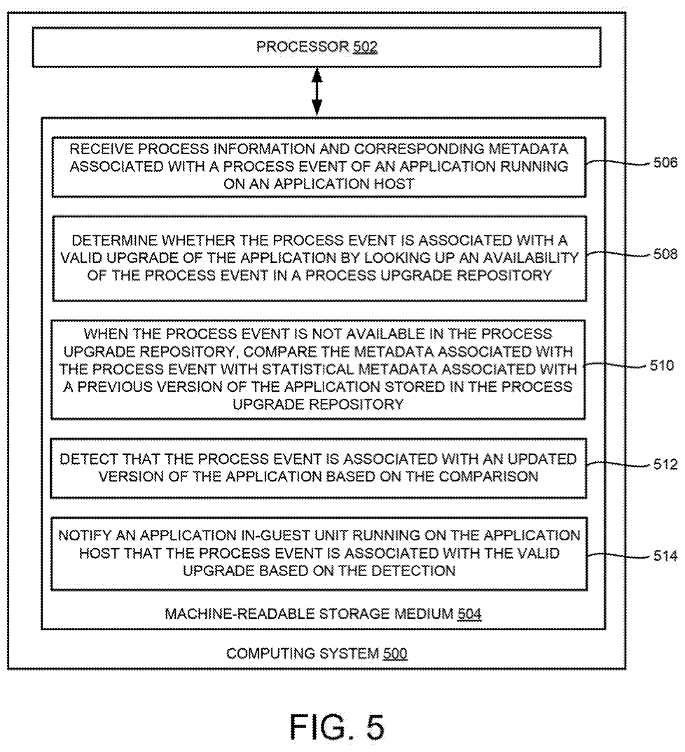

FIG. 5 is a block diagram of an example computing system 500 including non-transitory computer-readable storage medium, storing instructions to detect application upgrades based on process information and corresponding metadata. Computing system 500 may include a processor 502 and a machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to computing system 500.

Machine-readable storage medium 504 may store instructions 506-514. In an example, instructions 506-514 may be executed by processor 502 for detecting applications upgrades in a data center. Instructions 506 may be executed by processor 502 to receive process information and corresponding metadata associated with a process event of an application running on an application host. Instructions 508 may be executed by processor 502 to determine whether the process event is associated with a valid upgrade of the application by looking up an availability of the process event in a process upgrade repository. Further, machine-readable storage medium 504 may store instructions to notify an application in-guest unit running on the application host that the process event is associated with the valid upgrade when the process event is available in the process upgrade repository.

When the process event is not available in the process upgrade repository, instructions 510 may be executed by processor 502 to compare the metadata associated with the process event with statistical metadata associated with a previous version of the application stored in the process upgrade repository. Instructions to compare the metadata associated with the process event with the statistical metadata associated with the previous version of the application may include instructions to determine a process corresponding to the process information associated with the process event from the process upgrade repository, retrieve the statistical metadata associated with the previous version of the application from the process upgrade repository based on the determined process, and compare the metadata associated with the process event with the retrieved statistical metadata.

Instructions 512 may be executed by processor 502 to detect that the process event is associated with the valid upgrade of the application based on the comparison. Further, instructions 514 may be executed by processor 502 to notify the application in-guest unit running on the application host that the process event is associated with the valid upgrade based on the detection. Furthermore, the instructions may include to update the process upgrade repository with an updated version of the application upon detecting that the process event is associated with the valid upgrade of the application.

Machine-readable storage medium 504 may store instructions to detect that the process event is not associated with the valid upgrade of the application based on the comparison and notify the application in-guest unit running on the application host that the process event is not associated with the valid upgrade based on the detection.

Further, machine-readable storage medium 504 may store instructions to receive upgrade catalogues corresponding to an updated version of the application, parse process information and corresponding metadata of a process associated with the updated version of the application from the upgrade catalogues, and update the process upgrade repository with the parsed process information and the corresponding metadata as the updated version of the application.

Furthermore, machine-readable storage medium 504 may store instructions to retrieve one or more process events associated with a valid upgrade of the application from the plurality of application hosts and update the process upgrade repository with process information and metadata associated with the retrieved one or more process events associated with the valid upgrade of the application.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
receiving process information and corresponding metadata associated with a first process event of an application, wherein the application is to run on a first application host in a data center;
comparing the metadata associated with the first process event with statistical metadata associated with a previous version of the application using the process information;
detecting that the first process event is associated with a valid upgrade of the application based on the comparison; and
notifying an application in-guest unit running on the first application host that the first process event is associated with the valid upgrade based on the detection.

2. The method of claim 1, further comprising:
correlating, by the application in-guest unit, behaviors corresponding to the first process event with behaviors corresponding to the previous version of the application, and wherein the behaviors comprise at least one of network connections, system calls, and system files associated with the first process event.

3. The method of claim 1, wherein the first application host is one of a physical server, a virtual machine, and a container.

4. The method of claim 1, wherein the metadata comprises at least one of process binary hash information, process binary signing information, and process publisher information.

5. The method of claim 1, further comprising:
detecting that the first process event is not associated with the valid upgrade of the application based on the comparison; and
notifying the application in-guest unit running on the first application host that the first process event is not associated with the valid upgrade based on the detection.

6. The method of claim 1, wherein comparing the metadata associated with the first process event with the statistical metadata associated with the previous version of the application comprises:
determining a process corresponding to the process information associated with the first process event from a process upgrade repository;
retrieving the statistical metadata associated with the previous version of the application from the process upgrade repository based on the determined process; and
comparing the metadata associated with the first process event with the retrieved statistical metadata.

7. The method of claim 6, further comprising:
updating the process upgrade repository with an updated version of the application upon detecting that the first process event is associated with the valid upgrade of the application.

8. The method of claim 7, further comprising:
receiving process information and corresponding metadata associated with a second process event of the application running on a second application host;
looking-up the process upgrade repository to detect that the second process event is associated with the updated version of the application; and
notifying an application in-guest unit running on the second application host that the second process event is associated with the valid upgrade based on the detection.

9. A system comprising:
a plurality of application hosts executing a plurality of applications in a data center;
an application in-guest unit running on each of the plurality of application hosts to capture process information and corresponding metadata associated with process events of the plurality of applications running on the plurality of application hosts; and
a management node communicatively coupled to the plurality of application hosts via a network, wherein the management node comprises an application update detection unit to:
receive process information and corresponding metadata associated with a first process event from the application in-guest unit running on a first application host of the plurality of application hosts;
compare the metadata associated with the first process event with statistical metadata associated with a previous version of the application;
detect that the first process event is associated with a valid upgrade of the application based on the comparison; and
notify the application in-guest unit running on the first application host that the first process event is associated with the valid upgrade based on the detection.

10. The system of claim 9, wherein the application update detection unit is to:
detect that the first process event is not associated with the valid upgrade of the application based on the comparison; and
notify the application in-guest unit running on the first application host that the first process event is not associated with the valid upgrade based on the detection.

11. The system of claim 10, wherein the application in-guest unit is to:
permit execution behaviors of the first process event upon receiving the notification that the first process event is associated with the valid upgrade of the application, wherein permitting execution behavior comprises correlating behaviors corresponding to the first process event with behaviors corresponding to the previous version of the application; and
exclude execution behaviors of the first process event upon receiving the notification that the first process event is not associated with the valid upgrade of the application, wherein the behaviors comprise at least one of network connections, system calls, and system files associated with the first process event.

12. The system of claim 9, wherein the first application host is one of a physical server, a virtual machine, and a container.

13. The system of claim 9, wherein the application in-guest unit is to:
capture the process information and the corresponding metadata associated with the first process event; and
transmit the captured process information and the corresponding metadata to the application update detection unit when the first process event is occurred for a first time.

14. The system of claim 9, wherein the management node is communicatively coupled to a process upgrade repository to store statistical process information and corresponding metadata associated with the plurality of applications.

15. The system of claim 14, wherein the application update detection unit is to:
determine a process corresponding to the process information associated with the first process event from the process upgrade repository;
retrieve the statistical metadata associated with the previous version of the application from the process upgrade repository based on the determined process; and
compare the metadata associated with the first process event with the retrieved statistical metadata.

16. The system of claim 14, wherein the management node comprises a process updating unit to update the process upgrade repository with an updated version of the application when the application update detection unit detects that the first process event is associated with the valid upgrade of the application.

17. The system of claim 16, wherein the process updating unit is to:
receive upgrade catalogues corresponding to an updated version of the application;
parse process information and corresponding metadata of a process associated with the updated version of the application from the upgrade catalogues; and
update the process upgrade repository with the parsed process information and the corresponding metadata as the updated version of the application.

18. The system of claim 17, wherein the process updating unit is to:
retrieve one or more process events associated with a valid upgrade of the application from the plurality of application hosts; and
update the process upgrade repository with process information and metadata associated with the retrieved one or more process events associated with the valid upgrade of the application.

19. The system of claim 18, wherein the application update detection unit is to:
receive process information and corresponding metadata associated with a second process event of the application running on a second application host;
look-up the process upgrade repository to detect that the second process event is associated with the updated version of the application; and
notify an application in-guest unit running on the second application host that the second process event is associated with the valid upgrade based on the detection.

20. A non-transitory machine-readable storage medium encoded with instructions that, when executed by a processor of a computing system, cause the processor to:
receive process information and corresponding metadata associated with a process event of an application, wherein the application is to run on an application host in a data center;
determine whether the process event is associated with a valid upgrade of the application by looking up an availability of the process event in a process upgrade repository; and
when the process event is not available in the process upgrade repository:
compare the metadata associated with the process event with statistical metadata associated with a previous version of the application stored in the process upgrade repository;
detect that the process event is associated with the valid upgrade of the application based on the comparison; and
notify an application in-guest unit running on the application host that the process event is associated with the valid upgrade based on the detection.

21. The non-transitory machine-readable storage medium of claim 20, further comprising instructions that, when executed by the processor, cause the processor to:
notify the application in-guest unit running on the application host that the process event is associated with the valid upgrade when the process event is available in the process upgrade repository.

22. The non-transitory machine-readable storage medium of claim 20, wherein instructions to compare the metadata associated with the process event with the statistical metadata associated with the previous version of the application comprises instructions to:
determine a process corresponding to the process information associated with the process event from the process upgrade repository;
retrieve the statistical metadata associated with the previous version of the application from the process upgrade repository based on the determined process; and
compare the metadata associated with the process event with the retrieved statistical metadata.

23. The non-transitory machine-readable storage medium of claim 20, further comprising instructions that, when executed by the processor, cause the processor to:
detect that the process event is not associated with the valid upgrade of the application based on the comparison; and
notify the application in-guest unit running on the application host that the process event is not associated with the valid upgrade based on the detection.

24. The non-transitory machine-readable storage medium of claim 20, further comprising instructions that, when executed by the processor, cause the processor to: update the process upgrade repository with an updated version of the application upon detecting that the process event is associated with the valid upgrade of the application.

25. The non-transitory machine-readable storage medium of claim 20, further comprising instructions that, when executed by the processor, cause the processor to:
receive upgrade catalogues corresponding to an updated version of the application;
parse process information and corresponding metadata of a process associated with the updated version of the application from the upgrade catalogues; and
update the process upgrade repository with the parsed process information and the corresponding metadata as the updated version of the application.

26. The non-transitory machine-readable storage medium of claim 20, further comprising instructions that, when executed by the processor, cause the processor to:
retrieve one or more process events associated with a valid upgrade of the application from the plurality of application hosts; and
update the process upgrade repository with process information and metadata associated with the retrieved one or more process events associated with the valid upgrade of the application.
